(19) United States
(12) Patent Application Publication
(10) Pub. No.: US 2004/0137841 A1
(43) Pub. Date: Jul. 15, 2004

(54) Communication device and a link system for satellite communication

(76) Inventor: Per Wahlberg, Nacka (SE)

Correspondence Address: JACOBSON HOLMAN PLLC, 400 SEVENTH STREET N.W., SUITE 600, WASHINGTON, DC, 20004, US

(21) Appl. No.: 10/474,206

(22) PCT Filed: Apr. 19, 2002
(86) PCT No.: PCT/SE02/00774

(30) Foreign Application Priority Data
Apr. 20, 2001 (SE) 0101401-8

(51) Int. Cl. H04B 7/185; H04Q 7/20

(52) U.S. Cl. 455/12.1; 455/427

(57) ABSTRACT

A communication device for satellite communication via a satellite antenna unit, said communication unit including: a RF-converter for converting routed information carrying signals into RF-signals, a RF-signal amplifier, and a communication router with an internet communication unit. The unit is distinguished by the communication router, the RF-converter and the RF-signal amplifier being placed inside a sealed housing, which in a transport position forms a portable integral unit, and which in an active position forms the base for the satellite antenna unit. The invention also concerns a system for satellite communication including such a communication unit.

### FIELD OF THE INVENTION

The present invention relates to a communication device for satellite communication as defined in the preamble of claim 1. The invention also relates to a link system for satellite communication as defined in the preamble of claim 8.

### DESCRIPTION OF PRIOR ART

Mobile video link devices for satellite communication are well known and allows live video/audio transmission through vehicle carried equipment wherein heavy units such as amplifiers and power unites and bulky units such as the satellite antenna are supported by the vehicle.

Such systems make live transmission possible in a number of applications, provided it is possible to reach the place of interest by the vehicle. In recent years more compact equipment has been suggested, but the mobility thereof is still relatively limited because of the still considerable weight and bulk, also of the equipment in its transport position.

Altogether there are a number of drawbacks associated with the prior art systems, such as complexity, limited mobility, problems of easily reaching road-less territories and associated costs.

### SUMMARY OF THE INVENTION

It is an aim of this invention to provide a more user-friendly and even more mobile communication device of the above kind, wherein the drawbacks of the known art is reduced. In particular it is an aim of the invention to provide a communication device and a system for satellite communication, whereby easy handling and portability is achieved at least in a transport position.

These aims are obtained in a device and a link system according to the above through the features of the characterising portions of claim 1 and 8, respectively.

Hereby it is achieved that all elements making up an entire communication device are integrated into one single, portable package. By placing sensitive equipment inside the sealed housing it is achieved that the sensitivity for harsh or hostile environments is reduced to a minimum.

By using the housing with its contents of relatively heavy units as the base for the antenna unit in the active position is accentuates its user-friendliness and capacity to easily convert between a transport position and an active position.

The transmission capacity may be up to about 10 Mbit/s, but it is preferred that the transmission capacity of the resulting video link device is limited to about up to 2 Mbit/s. This feature makes it possible to employ pieces of equipment such as RF-amplifiers that are reduced in size and effect, whereby there is a corresponding reduced need of cooling the equipment which is placed inside the sealed housing. It could be mentioned that “normal” transmission capacity of a mobile video link device is at least 8 Mbit/s, which of course necessitates corresponding powerful amplifiers and a need for more cooling equipment.

It is more preferred that the transmission capacity is between 256 kbit/s and 2 Mbit/s, since that lower limit allows a transmission quality which is acceptable in some applications, but it is still more preferred that the transmission capacity is between 512 kbit/s and 2 Mbit/s since that lower limit ensures transmission quality of a level which is more acceptable in even more applications.

A transmission capacity in the neighbourhood of about 2 Mbit/s is thus most preferred, because of the transmission quality being almost in level with previous high capacity mobile units, at least for viewers or users others than a person skilled in the art.

According to one aspect of the invention the communication router includes means for antenna position control and function monitoring. This allows remote control of the antenna and also remote function monitoring. These features has proved to be very useful since hereby it is not necessary that a technically trained operator is present on the site where the video link device is established. Contrary it is possible to have technical staff placed centrally whereby it is possible for a photographer to handle installation and operation on the site.

According to another aspect of the invention the link system including the communication device includes a separate operator terminal for communication with the Internet communication means and the antenna positioner, for example over a LAN. This operator terminal may be used for controlling the video link device and also for example for other types of Internet transmissions such as file handling, e-mail transmission etc.

In order to ensure that video signal transmission is not disturbed by other Internet traffic it is preferred that the Internet communication means is arranged to favour the transmission of video signals before other Internet traffic. This could be accomplish by for example booking 1.9 Mbit/s out of 2 Mbit/s total capacity for video signals transmission and only allow 0.1 Mbit/s for various other Internet traffic.

By having the housing and the hood together forming a case containing the antenna unit, which in this case is separated in two separate parts and placed inside this hood, advantages further portability is guarantied.

An advantage with the present invention is that the communication device making up the link system is easy to move and requires no transportation means, such as a vehicle.

Another advantage is that the communication device makes it possible to establish a direct link from a camera, connected to the video link device, to any person connected to Internet.

Still another advantage is that the communication device enables broadband, preferably around 2 Mbit/s, transmission from practically any location world-wide.

### BRIEF DESCRIPTION OF THE DRAWINGS

FIG. 1 shows a simplified overview of satellite communication system including a link system for video communication using a communication device according to the invention.

FIG. 2 shows a block diagram of a video communication device according to the invention.

### DESCRIPTION OF PREFERRED EMBODIMENTS

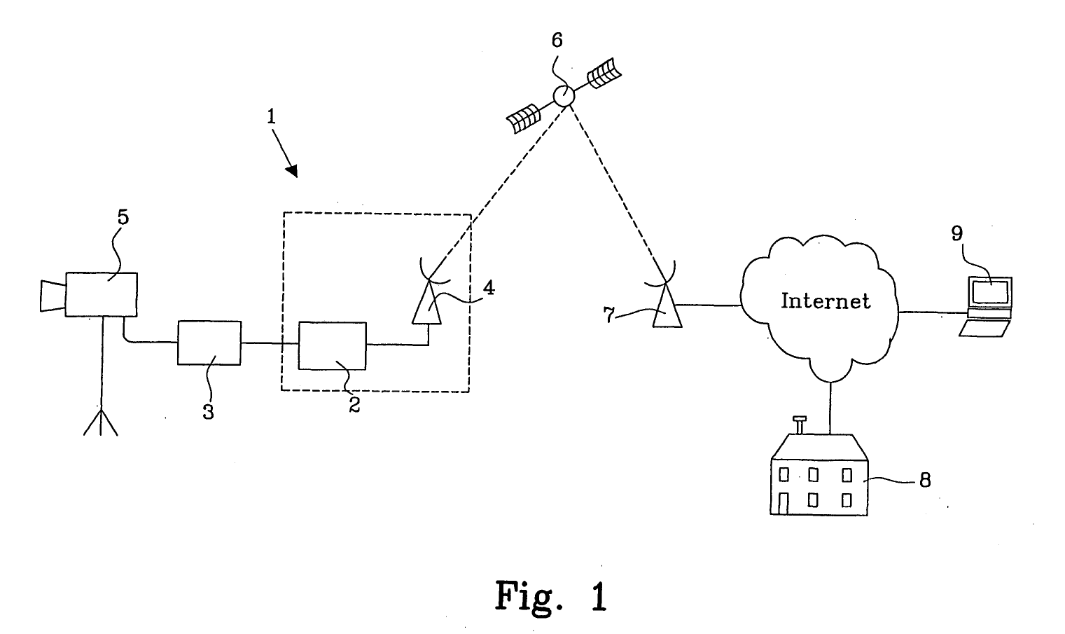

FIG. 1 is a simplified overview of a system for video communication via a satellite. 1 designates an up-link system according to the invention, in this embodiment including a communication unit 2, which is connected to an antenna unit 4, mainly for up-link purposes. A communication unit 2 is in this embodiment operated via an operator terminal 3, which could be a specially configured personal computer. The unit and the terminal are preferably connected via a local area network (LAN), which may be implemented by conventional cables or radio communication.

A video camera 5 is connected to the operator terminal over conventional cables. Other connection means are of course possible.

Signals transmitted by the antenna unit 4 are directed to a selected satellite 6, which transfers the signals to an appropriate frequency band and repeats them so as to be received by a down-link antenna unit 7. Signals received by the down-link antenna unit 7 are thereafter transmitted to the Internet so as to be available for an information provider 8, which could be a global television network operator or Internet users 9.

It should be noted that the satellite communication indicated in FIG. 1 may be bi-directional. In that case the entire capacity, e.g. 2 Mbit/s, is available in both directions. Hereby the communication unit and the antenna unit may be controlled and monitored from an authorised Internet user.

The operator terminal may also be used for control and monitoring. It may also be used for conventional Internet traffic such as surfing and e-mail.

Pictures, which may be coded, coded and compressed video signals, telephone, data, facsimile, computer signals, e-mail and/or Internet traffic or any other information carrying signals may thus be transmitted over the link system according to the invention.

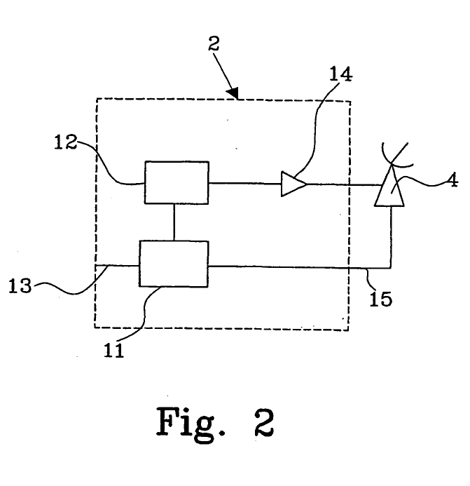

FIG. 2 shows diagrammatically the communication device 2 in connection with the antenna unit 4. The communication device is configured as a closed housing including therein a communication router 11, which includes an Internet communication unit, a RF-converter 12 for converting routed video signals from an input port 13 and passing them via an RF-amplifier 14 to said antenna unit 4.

The antenna unit includes a mechanical support having a base integral with the housing and holding elements being turnable and pivotable with respect to said base for directing an antenna element of the antenna unit to a selected satellite.

The communication router may include means for antenna position control as indicated by line 15 in FIG. 2.

The invention provides for portability by low effect components because of limited bandwidth. Less effect is needed to establish satellite communication, which results in less heat development to be transported from the inside of the sealed housing to ambient air. It also results in less EMC which allows denser packaging of the necessary components. Further, the components are packed such that particularly heat dissipating elements are placed in a manner so as they are close to or in direct contact with a heat-transferring wall of the housing.

By selecting and re-designing components with respect to minimising size and power consumption it is possible to pack them in an advantageous manner and use a reduced supply voltage to the components which in turn reduces heat development.

1. A communication device for satellite communication via a satellite antenna unit, said communication unit including:
a RF-converter for converting routed information carrying signals into RF-signals,
a RF-signal amplifier, and
a communication router with an internet communication unit,
characterised in that the communication router, the RF-converter and the RF-signal amplifier are placed inside a sealed housing, which in a transport position forms a portable integral unit, and which in an active position forms the base for the satellite antenna unit.

2. The communication device according to claim 1, wherein the communication router includes means for antenna position control and function monitoring.

3. The communication device according to claim 2, wherein the communication device further includes an encoder for information carrying signals for compression encoding incoming signals to be passed on to the RF-converter via said communication router.

4. The communication device according to any of the previous claims, wherein the transmission capacity is between 256 kbit/s and 2 Mbit/s.

5. The communication device according to claim 4, wherein the transmission capacity is between 512 kbit/s and 2 Mbit/s.

6. The communication device according to claim 5, wherein the transmission capacity is about 2 Mbit/s.

7. The communication device according to any of the previous claims, wherein the Internet communication unit is arranged to favour the transmission of video signals before other Internet traffic.

8. A link system for satellite communication including:
a communication device according to any of claims 1-7, and
an antenna unit being connected to an output of the RF signal amplifier, said antenna unit including an antenna positioner for directing a satellite antenna to a selected satellite for transmitting the amplified RF-signals to the selected satellite.

9. The system according to claim 8, wherein an operator terminal is connected to the communication device for communication with the internet communication unit and the antenna positioner of the antenna unit.

10. The system according to claim 9, wherein the operator terminal includes a terminal router for packing the compression encoded signals.

11. The system according to claim 9 or 10, wherein the encoder for information carrying signals is positioned in the operator terminal.

12. The system according to any of claims 8-11, wherein the system further includes a hood, the sealed housing of the communication device together with the hood form parts of a case which in the transport position is arranged to contain the antenna unit.
